(19) United States
(12) Patent Application Publication
(10) Pub. No.: US 2010/0052918 A1
(43) Pub. Date: Mar. 4, 2010

(54) Method and Device for Training Young Children to Fall Asleep

(75) Inventors: John J. Walker, Pittsburgh, PA (US); Mary Koes, Pittsburgh, PA (US); Robert D. Daley, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: THORLEY INDUSTRIES, LLC, Pittsburgh, PA (US)

(21) Appl. No.: 12/551,624

(22) Filed: Sep. 1, 2009

Related U.S. Application Data
(60) Provisional application No. 61/094,383, filed on Sep. 4, 2008.

(51) Int. Cl. G08B 23/00

(52) U.S. Cl. 340/575

(57) ABSTRACT

A sleep training device for assisting caregivers in training infants to sleep includes: a housing; a controller disposed within the housing; and an input device configured to be accessed from outside the housing and operationally coupled to the controller. The input device is provided for allowing a caregiver to input status information of an infant. The sleep training device also includes a storage device disposed within the housing and operationally coupled to the controller, the storage device provided to store training data regarding a sleep training regimen; and a display viewable from outside the housing and operationally coupled to the controller. The controller a) receives the status information from the input device and the training data from the storage device; b) based on the status information and the training data, calculates care instructions; and c) provides instructions to the display to present the care instructions to the caregiver.

### CROSS REFERENCE TO RELATED APPLICATIONS

This application is based on U.S. Provisional Patent Application No. 61/094,383, filed Sep. 4, 2008, on which priority of this patent application is based and which is hereby incorporated by reference in its entirety.

### BACKGROUND OF THE INVENTION

1. Field of the Invention

The present invention relates generally to a system for helping infants learn to settle themselves to sleep and, in particular, a system for assisting parents in helping their children learn to fall asleep by themselves, sleep longer, and develop a consistent routine.

2. Description of Related Art

Bedtime for very young children can be a difficult and confusing time. After being held, swaddled, fed, and entertained by parents in between naps all day, children are suddenly left in a semi-dark room. The lack of stimulus or parental presence can be difficult for very young children to understand.

It has been discovered that the skill of settling down to sleep is a learned one. It is not surprising, then, that young children sometimes have a hard time understanding that they are to go to sleep when placed in their cribs and they cry. The natural parental reaction is to want to return to the children's bedrooms and pick them up to soothe them. Assuming the children are not ill and do not have a medical condition, however, returning to the room immediately is often the worst thing a parent can do in terms of teaching their children to settle themselves to sleep because all it really teaches them is that crying out causes their parent to return to pay attention to them.

Sleep experts have written dozens of books that detail proven methods to help infants get to sleep and sleep through the night. As written about by Dr. Ferber and many others, by gradually increasing the amount of time parents let their children cry after being placed down to bed, the children learn to soothe themselves to sleep while still getting the parental support that is important for good childhood development.

Heretofore, however, such methods have been dependent on the parents' time and ability to read, learn, and memorize those methods in order to employ them effectively. What is needed is an automated way to assist the parents in the implementation of said methods.

### SUMMARY OF THE INVENTION

The present invention is a sleep training device for assisting caregivers in training infants to sleep. The sleep training device includes: a housing; a controller disposed within the housing; and an input device configured to be accessed from outside the housing and operationally coupled to the controller. The input device is provided for allowing a caregiver to input status information of an infant. The sleep training device also includes a storage device disposed within the housing and operationally coupled to the controller, the storage device provided to store training data regarding a sleep training regimen; and a display viewable from outside the housing and operationally coupled to the controller. The controller a) receives the status information from the input device and the training data from the storage device; b) based on the status information and the training data, calculates care instructions; and c) provides instructions to the display to present the care instructions to the caregiver.

The input device may include at least one button, and desirably four buttons. The four buttons may be a first button that is pressed if an infant is awake to play, a second button that is pressed if the infant is awake and crying, a third button that is pressed if the infant is placed down to sleep, and a fourth button that is pressed when the caregiver checks on the infant during sleep.

The display may be a backlit, liquid crystal device (LCD) screen. The display may include a graphical representation of an infant in different states. The different states may be (1) awake, (2) crying, and (3) sleeping. The display may also include a first timer display and a second timer display. The storage device may be Electrically Erasable Programmable Read-Only Memory (EEPROM).

The present invention is also directed to a method of providing infant sleep training assistance to a caregiver. The method includes the steps of: providing a sleep training data set; gathering status information about the status of the infant; providing a computing device having access to the sleep training data set and the status of the infant and having software operable to determine care instructions based on the sleep training data set and the status information; providing a presentation device configured to receive the care instructions from the computing device; and presenting the care instructions to the caregiver using the presentation device.

The status information may be provided to the computing device using an input device provided on the computing device that includes at least one button, and desirably four buttons. The four buttons may include a first button that is pressed if an infant is awake to play, a second button that is pressed if the infant is awake and crying, a third button that is pressed if the infant is placed down to sleep, and a fourth button that is pressed when the caregiver checks on the infant during sleep.

The presentation device may be a backlit, LCD screen. The presentation device may include a graphical representation of an infant in different states. The different states may be (1) awake, (2) crying, and (3) sleeping. The presentation device may include a first timer display and a second timer display.

The present invention is also a system for assisting a caregiver in training an infant to fall sleep. The system includes training data regarding a sleep training regimen; status information about the status of the infant; a computing device having access to the training data and the status information and having software that calculates care instructions based on the training data and the status information; and a presentation device in communication with the computing device. The presentation device is configured to present care instructions to the caregiver, whereby the infant is trained to fall asleep.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of a sleep training device in accordance with the present invention;

FIG. 2 illustrates an exemplary device in an “up to play” condition in accordance with the present invention;

FIG. 3 is a detailed view of a “down to sleep” form, shown on the display screen;

FIG. 4 illustrates a “crying” form, shown on the display screen, showing a graphical illustration of a crying baby face with tears and a first and second timer;

FIG. 5 illustrates a “go check” form, shown on the display screen, showing a graphical illustration of a crying baby face with tears and a first and second timer; and

FIG. 6 depicts a look-up table to be used with the invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The system and method of the present invention can be implemented using a general purpose computer, a portable handheld computing or electronic device, with or without Internet connectivity.

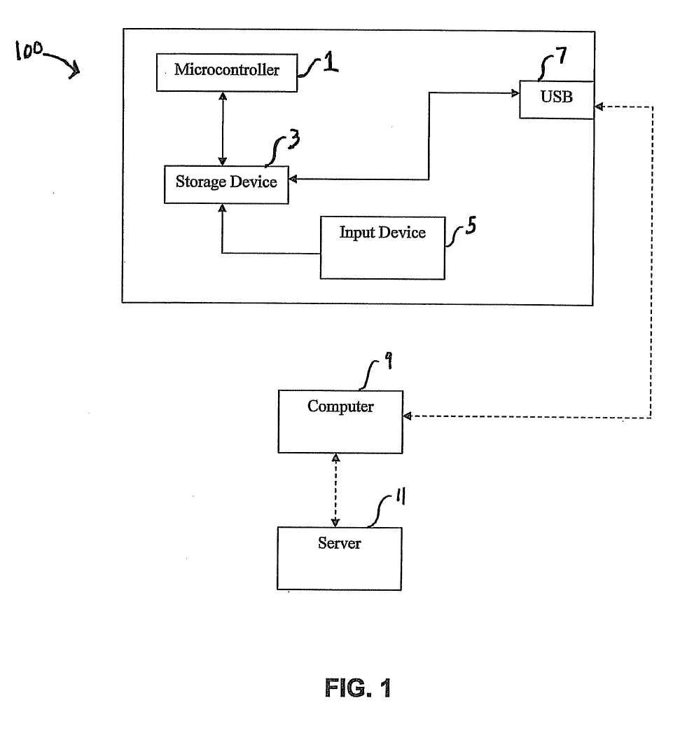

With reference to FIG. 1, a sleep training device 100 in accordance with the present invention includes a microcontroller 1 operationally coupled to a storage device 3. The storage device 3 is configured to receive information from an input device 5 of sleep training device 100. Input device 5 may be configured as buttons 120, 130, 140, and 150 as described in greater detail hereinafter. Storage device 3 is operationally coupled to send and receive information to a data communication port, such as universal serial bus (USB) port 7. USB port 7 allows sleep training device 100 to communicate with a personal computer 9. The various data obtained by sleep training device 100 is thereby transferred to personal computer 9 where the data is processed. In addition, personal computer 9 can communicate the processed data to a server 11 where the processed data can be further processed and/or compared to processed data from other sleep training device or exemplary data.

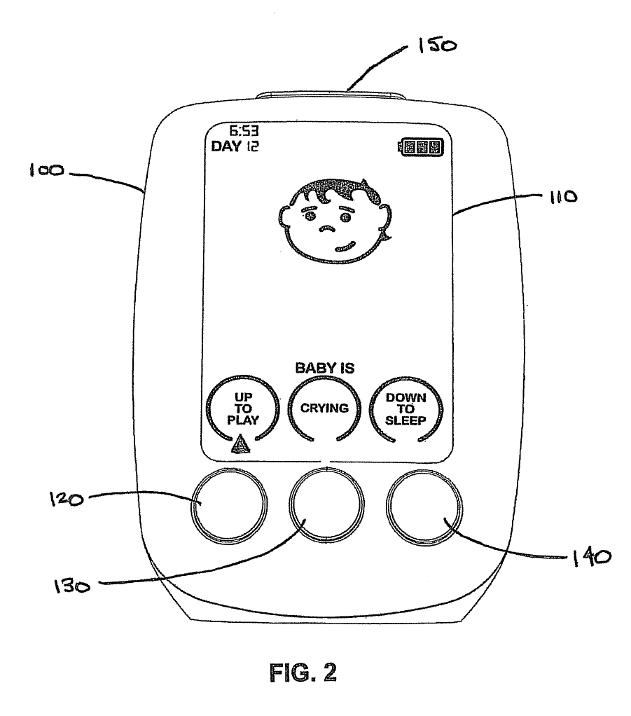

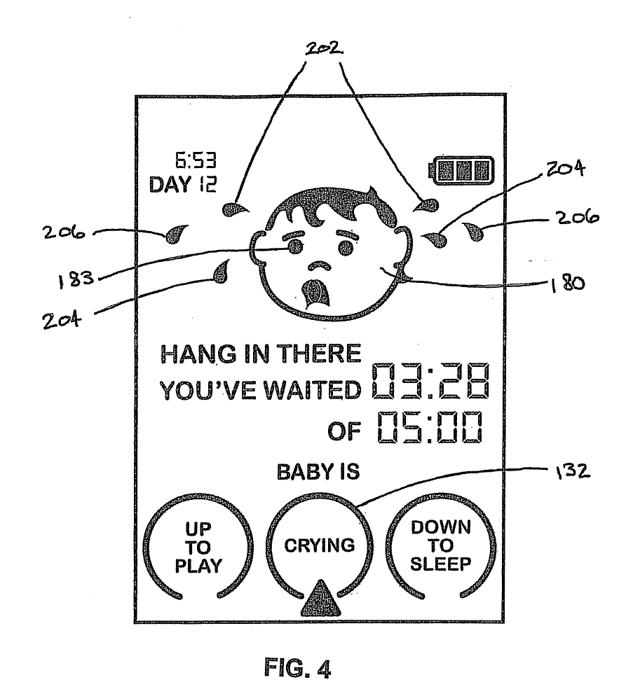

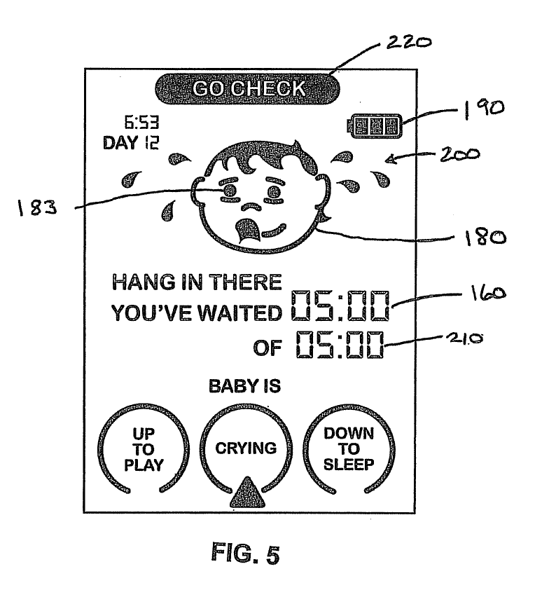

A sleep training system and device embodying various aspects of the present invention is shown in FIGS. 2-5. It will be readily apparent to those skilled in the art, however, that the disclosed sleep training device represents but one of a wide variety of structures, configurations, and modes of operation of devices that fall within the scope of the present invention.

With reference to FIG. 2, a sleep training device 100 is provided to a parent wanting to train his/her child to fall asleep. Handheld device 100 has a display screen 110 for providing interaction between the parent and the handheld device 100. Optionally, display screen 110 can be overlaid by a transparent, touch-sensitive input surface, obviating the need for buttons.

Handheld device 100 has an “up to play” button 120, a “crying” button 130, a “down to sleep” button 140 and a “go check” button 150, providing a surprisingly simple to use user interface. The “up to play” button 120 is used to indicate that the child is awake and it is not time for them to be sleeping. Typically, this will occur during the day and this state is represented by the display shown in FIG. 2. The remainder of the buttons will be discussed in the following explanation:

The following are user scenarios for the sleep trainer handheld device 100 with the actions that should be performed in the microprocessor code.

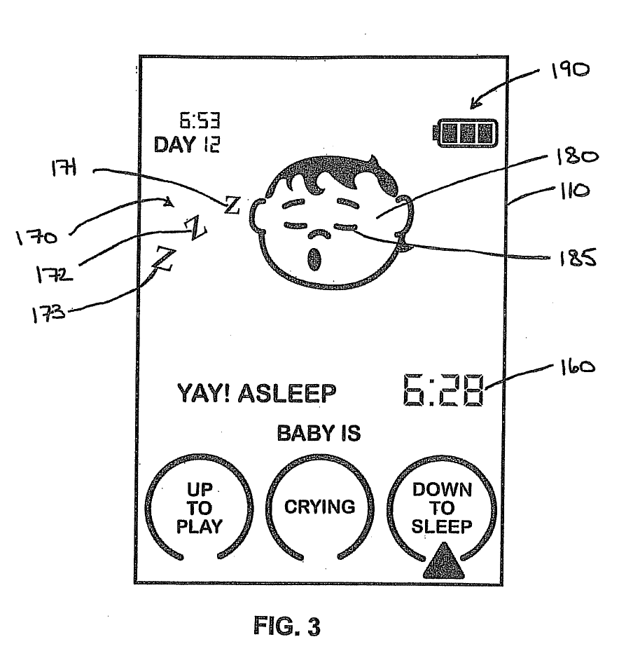

Referring now to FIG. 3, in scenario #1, the child is about to be put to bed for the night and the parent places the child down and then presses the “down to sleep” button 140. The display 110 will appear as shown in FIG. 3.
The handheld device 100 detects the pressing of the button 140.
The handheld device 100 logs the state as “SLEEP”.
The handheld device 100 logs the date and time.

| SEGMENT | STATE (0 = off, 1 = on) |
|---|---|
| Tears | 0 |
| Z's | 1 |
| DAY | 1 |
| HANG IN THERE YOU'VE | 0 |
| WAITED OF | |
| YAY! ASLEEP | 1 |
| BABY IS | 1 |
| TRIANGLE in up to play | 0 |
| TRIANGLE in crying | 0 |
| TRIANGLE in down to sleep | 1 |
| Head, nose, and eyebrows | 1 |
| Eyes awake | 0 |
| Eyes asleep | 1 |
| Mouth smile | 0 |
| Mouth sleep | 1 |
| Mouth crying | 0 |
| Battery frame | 1 |
| Battery nugget 1 | 1/0 |
| Battery nugget 2 | 1/0 |
| Battery nugget 3 | 1/0 |
| Battery nugget 4 | 1/0 |
| Clock | 1 |
| Upper Timer | 0 |
| Lower Timer | 1 |
| GO CHECK | 0 |
| Backlight | 1/0 |

The handheld device 100 begins counting up on a timer display 160 to indicate the time that has elapsed since the “down to sleep” button 140 was pressed. It should count in seconds until one minute is reached and then count in minutes and hours afterwards.
The handheld device 100 animates one or a plurality of “Z's” 170 by turning on the Z 171 closest to a baby face 180 first for one second, then the next closest Z 172 for one second, and finally the furthest Z 173 from the face for one second. Finally, all the Z's 170 are turned off for one second. Once this one second time period has expired, the process repeats itself.
The handheld device 100 should update a battery icon 190 on a regular basis based on the battery charge remaining.
The handheld device 100 should light the backlight (not shown) anytime any of the buttons 120, 130, 140, 150 are pushed or a timer display 160 reflects an expired condition. The backlight should be powered off otherwise in order to conserve power.

Referring now to FIGS. 3-5, in scenario #2, the child wakes up and is crying.

The parent presses the “crying” button 130, which highlights the crying button display 132.
The handheld device 100 detects the pressing of the “crying” button 130.
The handheld device 100 logs the state as “CRY”.
The handheld device 100 logs the date and time.
The handheld device 100 accesses a look-up table 300 using the current day in the training cycle along with the number of times the “crying” button 130 has been pressed since the “down to sleep” button 140 was pressed. The look-up table 300 returns the time value that should be displayed in the timer display 160.

| SEGMENT | STATE (0 = off, 1 = on) |
|---|---|
| Tears | 1/0 |
| Z's | 0 |
| DAY | 1 |
| HANG IN THERE YOU'VE | 1 |
| WAITED OF | |
| YAY! ASLEEP | 0 |
| BABY IS | 1 |
| TRIANGLE in up to play | 0 |
| TRIANGLE in crying | 1 |
| TRIANGLE in down to sleep | 0 |
| Head, nose, and eyebrows | 1 |
| Eyes awake | 1 |
| Eyes asleep | 0 |
| Mouth smile | 0 |
| Mouth sleep | 0 |
| Mouth crying | 1 |
| Battery frame | 1 |
| Battery nugget 1 | 1/0 |
| Battery nugget 2 | 1/0 |
| Battery nugget 3 | 1/0 |
| Battery nugget 4 | 1/0 |
| Clock | 1 |
| Upper Timer | 1 |
| Lower Timer | 1 |
| GO CHECK | 0/1 |
| Backlight | 1/0 |

The handheld device 100 animates tears 200 by turning on the closest tears 202 to the baby face 180 first for one second, then the next closest tears 204 for one second, and finally the furthest tears 206 from the baby face 180 for one second. Finally, all the tears 200 are turned off for one second. Once this one second time period has expired, the process repeats itself.
The timer display 160 begins to count up from 0:00 in one second increments
When timer display 160 is equal to a second time display 210, a “go check” display 220 begins blinking and a tone should sound. The blink rate and tone should be synchronized and should be running at a 0.5 Hz-1 Hz rate.
Timer display 160 should continue counting up.
The handheld device 100 should update the battery icon 190 on a regular basis based on the battery charge remaining.
The handheld device 100 should light the backlight anytime a button 120, 130, 140, 150 is pushed or a timer display 160 expires. The backlight should be powered off otherwise in order to conserve power.

In scenario #3, once the timer display 160 equals the second time display 210, the parent goes to check on the child.

The parent presses the “go check” button 150.
The handheld device 100 detects the pressing of the button 150.
The handheld device 100 silences the tone.
Timer display 160 should stop counting and stay at the reached value.
The handheld device 100 logs the state as “CHECK”.
The handheld device 100 logs the date and time.

| SEGMENT | STATE (0 = off, 1 = on) |
|---|---|
| Tears | 0 |
| Z's | 0 |
| DAY | 1 |
| HANG IN THERE YOU'VE | 1 |
| WAITED OF | |
| YAY! ASLEEP | 0 |
| BABY IS | 1 |
| TRIANGLE in up to play | 0 |
| TRIANGLE in crying | 1 |
| TRIANGLE in down to sleep | 0 |
| Head, nose, and eyebrows | 1 |
| Eyes awake | 1 |
| Eyes asleep | 0 |
| Mouth smile | 0 |
| Mouth sleep | 0 |
| Mouth crying | 1 |
| Battery frame | 1 |
| Battery nugget 1 | 1/0 |
| Battery nugget 2 | 1/0 |
| Battery nugget 3 | 1/0 |
| Battery nugget 4 | 1/0 |
| Clock | 1 |
| Upper Timer | 1 |
| Lower Timer | 0 |
| GO CHECK | 0 |
| Backlight | 1/0 |

The handheld device 100 should update the battery icon 190 on a regular basis based on the battery charge remaining.
The handheld device 100 should light the backlight anytime a button 120, 130, 140, 150 is pushed or the timer display 160 expires. The backlight should be powered off otherwise in order to conserve power.

In scenario #4, the parent has checked on the child and leaves the room. The parent presses the “down to sleep” button 140.
The handheld device 100 detects the pressing of the button.
The handheld device 100 logs the state as “SLEEP”.
The handheld device 100 logs the date and time.
The handheld device 100 sets timer display 160 to 0:00.
The handheld device 100 begins counting up on timer display 160 to indicate the time that has elapsed since the “down to sleep” button 140 was pressed.

| SEGMENT | STATE (0 = off, 1 = on) |
|---|---|
| Tears | 0 |
| Z's | 1/0 |
| DAY | 1 |
| HANG IN THERE YOU'VE | 0 |
| WAITED OF | |
| YAY! ASLEEP | 1 |
| BABY IS | 1 |
| TRIANGLE in up to play | 0 |
| TRIANGLE in crying | 0 |
| TRIANGLE in down to sleep | 1 |
| Head, nose, and eyebrows | 1 |
| Eyes awake | 0 |
| Eyes asleep | 1 |
| Mouth smile | 0 |
| Mouth sleep | 1 |
| Mouth crying | 0 |
| Battery frame | 1 |
| Battery nugget 1 | 1/0 |
| Battery nugget 2 | 1/0 |
| Battery nugget 3 | 1/0 |
| Battery nugget 4 | 1/0 |
| Clock | 1 |
| Upper Timer | 1 |
| Lower Timer | 0 |
| GO CHECK | 0 |
| Backlight | 1/0 |

The handheld device 100 animates the “Z's” 170 by turning on the closest Z 171 to the face 180 first for one second, then the next closest Z 172 for one second, and finally the furthest Z 173 from the face for one second. Finally, all the Z's are turned off for one second. Once this one second time period has expired, the process repeats itself.
The handheld device 100 should update the battery icon 190 on a regular basis based on the battery charge remaining.
The handheld device 100 should light the backlight anytime a button 120, 130, 140, 150 is pushed or the display timer 160 expires. The backlight should be powered off otherwise in order to conserve power.

It is expected that scenarios #2 through #4 could be repeated several times through the night.

In scenario #5, the child wakes up in the morning. The parent presses the “up to play” button 120.
The handheld device 100 detects the pressing of the button 120.
The handheld device 100 logs the state as “UP”.
The handheld device 100 logs the date and time.

| SEGMENT | STATE (0 = off, 1 = on) |
|---|---|
| Tears | 0 |
| Z's | 0 |
| DAY | 1 |
| HANG IN THERE YOU'VE | 0 |
| WAITED OF | |
| YAY! ASLEEP | 0 |
| BABY IS | 1 |
| TRIANGLE in up to play | 1 |
| TRIANGLE in crying | 0 |
| TRIANGLE in down to sleep | 0 |
| Head, nose, and eyebrows | 1 |
| Eyes awake | 1/0 |
| Eyes asleep | 0/1 |
| Mouth smile | 1 |
| Mouth sleep | 0 |
| Mouth crying | 0 |
| Battery frame | 1 |
| Battery nugget 1 | 1/0 |
| Battery nugget 2 | 1/0 |
| Battery nugget 3 | 1/0 |
| Battery nugget 4 | 1/0 |
| Clock | 1 |
| Upper Timer | 0 |
| Lower Timer | 0 |
| GO CHECK | 0 |
| Backlight | 1/0 |

The handheld device 100 simulates animation by turning on the eyes awake display 183 and turning off the eyes closed display 185 for ten seconds, then turning on the eyes closed and turning off the eyes open for one second. Then repeat.
The handheld device 100 should update the battery icon 190 on a regular basis based on the battery charge remaining.
The handheld device 100 should light the backlight anytime a button 120, 130, 140, 150 is pushed or the display timer 160 expires. The backlight should be powered off otherwise in order to conserve power.

In scenario #6, the parent connects the handheld device 100 to a USB port of personal computer 9.
The handheld device 100 detects the presence of the USB connection.
The handheld device 100 waits to receive a command from the personal computer (PC).
When a “SEND DATA” command is received, the handheld device 100 begins transmitting the logged data to the PC.
When a “CLEAR DATA” command is received, the handheld device 100 will erase the EEPROM.
When a “DISCONNECT” command is received, the handheld device 100 will go into a sleep mode.

Real-Time Clock

The sleep trainer will require various components to achieve the above listed scenarios. There will be a need for a real-time clock (RTC) chip that will need to maintain reasonably accurate time even if the sleep trainer's main batteries should run low and need to be replaced. This will require that the RTC either have its own battery or perhaps a super capacitor that can hold a charge long enough to replace the sleep trainer's main batteries. The RTC will most likely require its own crystal in order to maintain the accurate time base. One such chip that would meet the specification would be the Dallas Semiconductor DS1302 RTC. This chip uses a simple 3-wire interface to the microcontroller. The chip maintains time in hours, minutes, and seconds as well as the date in year, month, day, and day of week valid until the year 2100.

For logging times and dates in the sleep trainer, the RTC chip reports the information in the following way:

RTC

| READ | WRITE | BIT 7 | BIT 6 | BIT 5 | BIT 4 | BIT 3 | BIT 2 | BIT 1 | BIT 0 | RANGE |
|---|---|---|---|---|---|---|---|---|---|---|
| 81h | 80h | CH | 10 Seconds | | | Seconds | | | | 00-59 |
| 83h | 82h | | 10 Minutes | | | Minutes | | | | 00-59 |
| 85h | 84h | 12/ 2̅4̅ | 0 | 10 | Hour | Hour | | | | 1-12/0-23 |
| | | | | A̅M̅/PM | | | | | | |
| 87h | 86h | 0 | 0 | 10 Date | | Date | | | | 1-31 |
| 89h | 88h | 0 | 0 | 0 | 10 | Month | | | | 1-12 |
| | | | | | Month | | | | | |
| 8Bh | 8Ah | 0 | 0 | 0 | 0 | 0 | Day | | | 1-7 |
| 8Dh | 8Ch | 10 Year | | | | Year | | | | 00-99 |
| 8Fh | 8Eh | WP | 0 | 0 | 0 | 0 | 0 | 0 | 0 | — |
| 91h | 90h | TCS | TCS | TCS | TCS | DS | DS | RS | RS | — |

Therefore, to perform the desired logging into the EEPROM, the following scheme could be implemented:
8-bits used for the state (UP, CRY, DOWN)
8-bits used for the minutes
8-bits used for the hour
8-bits used for the date
8-bits used for the year
8-bits used for checksum

All of the above would constitute a single event. This means that each logged event would require six bytes of EEPROM, assuming 8-bits=1-byte. If it is assumed 50 events per day were logged for one month, that would be 1500 events total, meaning an EEPROM capable of holding 9000 bytes of data would be required which is relatively small.

While the above described intelligent storage algorithm was described, this is not to be construed as limiting the present invention as any suitable storage algorithm may be utilized.

EEPROM

Storage device 3 may be embodied as EEPROM. As mentioned above, the size of the EEPROM is relatively small. Of course it may be the case that the chosen microcontroller possesses the required storage space internally in which case an external EEPROM will not be needed. However, if an external EEPROM is needed one possible choice could be the Microchip 24AA256. This EEPROM is a 32K×8 EEPROM that implements an I²C interface requiring only two I/O lines from the microcontroller.

USB Port

There are several microcontrollers on the market today that have an embedded USB port 7. It is also possible to add the USB functionality to a microcontroller that does not have an embedded USB port. For instance, an FT232R chip may be utilized and offers a USB solution that includes royalty free USB drivers that will operate with the various Windows, Mac, and Linux operating systems. Any USB implementation would be acceptable; however, at a minimum, support for the following operating systems must be included: Windows 2000, Windows XP, Windows Vista, Mac OS 9, and Mac OS X.

Liquid Crystal Device (LCD)

It is anticipated that the LCD used in the handheld device 100 will be a custom printed design meeting the following criteria.

1. Viewing area: 2″×3″ or 50.8×76.2 mm

2. Segments:
6 tears=6
3Z's=3
“Day”=1
“Hang in there you've waited/of”=1
“Yay! Asleep”=1
“Baby is” plus three buttons (“up to play”, “crying”, “down to sleep”) all always on=1 (could be tied to baby)
Three triangles corresponding to buttons=3
Head, nose, and eyebrows (always on)=1
Awake eyes=1
Sleeping eyes=1
Smile mouth=1
Sleeping mouth=1
Crying mouth=1
Battery: frame+3 nuggets=4
Numbers:
   Clock (7×3+2+1=24)
   Day (2+7=9)
   Upper timer (7*4+1=29)
   Lower timer (7*4+1=29)
Go check button=1

Total is approximately 118 segments

3. Blue backlight

4. It is recommended to use a TN fluid, positive image, trans-reflective polarizer

5. 6:00 viewing angle, operating temperature 0° C. to 50° C., storage temp −10° C. to 60° C.

Software Related Features of the Present Invention

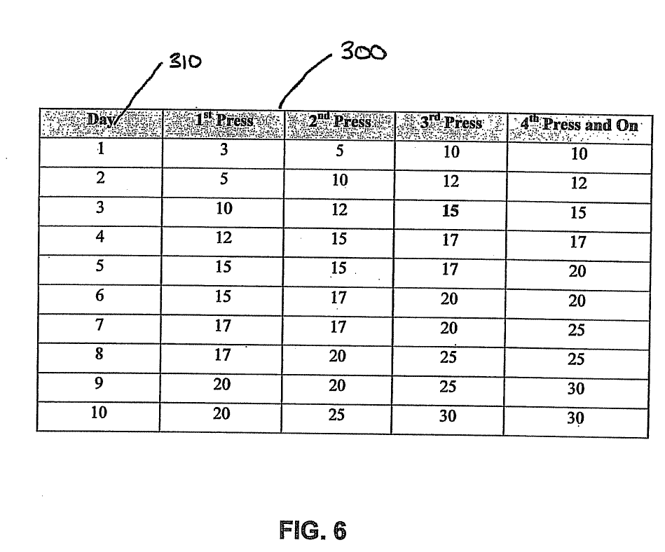

Referring now to FIG. 6, as mentioned above in Scenario #2 the time that second time display 210 is set to be determined by using the current day 310 in the training schedule coupled with the number of times the “crying button” 130 has been pressed. These will form an address into a look-up table 300. This second time display value 210 will be in units of minutes. As an example, if the handheld device 100 is on training day 3 and the “crying button” 130 has been pressed for the third time, the value of the second time display should read 15:00.

One possible suggestion for implementation of the look-up table 300 would be to simply declare a two-dimensional array based on the day and cry variables. Implementing this in an ANSIC compatible compiler would look like the following:

const int LUT[10][4]={{3,5,10,10},
{5,10,12,12},
{10,12,15,15},
{20,25,30,30}};

Using the example from above, the user would retrieve the second time display 210 value as follows:

int day=3;

int cry=3;

int t2_value=LUT[day][cry]; //t2_value will equal 15

The actual code used to implement the look-up table 300 will vary depending on the microcontroller used as well as the compiler and language. But such implementation is well known in the art. In addition, the present invention may be embodied as a software application for a portable communication device such as an iphone® or Blackberry®.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. A sleep training device for assisting caregivers in training infants to sleep comprising:
a housing;
a controller disposed within the housing;
an input device configured to be accessed from outside the housing and operationally coupled to the controller, the input device provided for allowing a caregiver to input status information of an infant;
a storage device disposed within the housing and operationally coupled to the controller, the storage device provided to store training data regarding a sleep training regimen; and
a display viewable from outside the housing and operationally coupled to the controller,
wherein the controller: a) receives the status information from the input device and the training data from the storage device; b) based on the status information and the training data, calculates care instructions; and c) provides instructions to the display to present the care instructions to the caregiver.

2. The sleep training device of claim 1, wherein the input device includes at least one button.

3. The sleep training device of claim 2, wherein the input device includes four buttons.

4. The sleep training device of claim 3, wherein a first button is pressed if an infant is awake to play, a second button is pressed if the infant is awake and crying, a third button is pressed if the infant is placed down to sleep, and a fourth button is pressed when the caregiver checks on the infant during sleep.

5. The sleep training device of claim 1, wherein the display is a liquid crystal device (LCD) screen.

6. The sleep training device of claim 5, wherein the LCD screen is backlit.

7. The sleep training device of claim 1, wherein the display includes a graphical representation of an infant in different states.

8. The sleep training device of claim 7, wherein the different states are (1) awake, (2) crying, and (3) sleeping.

9. The sleep training device of claim 1, wherein the display includes a first timer display and a second timer display.

10. The sleep training device of claim 1, wherein the storage device is Electrically Erasable Programmable Read-Only Memory (EEPROM).

11. A method of providing infant sleep training assistance to a caregiver comprising:
providing a sleep training data set;
gathering status information about the status of the infant;
providing a computing device having access to the sleep training data set and the status of the infant, said computing device having software operable to determine care instructions based on the sleep training data set and the status information;
providing a presentation device configured to receive the care instructions from the computing device; and
presenting the care instructions to the caregiver using the presentation device.

12. The method of claim 11, wherein the status information is provided to the computing device using an input device provided on the computing device that includes at least one button.

13. The method of claim 12, wherein the input device includes four buttons.

14. The method of claim 13, wherein a first button is pressed if an infant is awake to play, a second button is pressed if the infant is awake and crying, a third button is pressed if the infant is placed down to sleep, and a fourth button is pressed when the caregiver checks on the infant during sleep.

15. The method of claim 11, wherein the presentation device is an LCD screen.

16. The method of claim 15, wherein the LCD screen is backlit.

17. The method of claim 11, wherein the presentation device includes a graphical representation of an infant in different states.

18. The method of claim 17, wherein the different states are (1) awake, (2) crying, and (3) sleeping.

19. The method of claim 11, wherein the presentation device includes a first timer display and a second timer display.

20. A system for assisting a caregiver in training an infant to fall sleep comprising:
training data regarding a sleep training regimen;
status information about the status of the infant;
a computing device having access to the training data and the status information, said computing device having software that calculates care instructions based on the training data and the status information; and
a presentation device in communication with the computing device, the presentation device configured to present care instructions to the caregiver, whereby the infant is trained to fall asleep.
